(19) United States
(12) Patent Application Publication
(10) Pub. No.: US 2014/0238919 A1
(43) Pub. Date: Aug. 28, 2014

(54) APPARATUS FOR FLOW PATH MODIFICATION IN A WATER FILTER SYSTEM

(71) Applicant: GENERAL ELECTRIC COMPANY, Schenectady, NY (US)

(72) Inventor: Timothy Scott Shaffer, LaGrange, KY (US)

(73) Assignee: GENERAL ELECTRIC COMPANY, Schenectady, NY (US)

(21) Appl. No.: 13/774,299

(22) Filed: Feb. 22, 2013

(51) Int. Cl. C02F 1/00

(52) U.S. Cl. CPC C02F 1/001
USPC 210/232

(57) ABSTRACT

A filter canister apparatus for engagement with a manifold includes an inlet annular recess defined by a mating surface, and at least a first set of embossments displaced and/or defined upon the mating surface separated approximately 180 degrees apart from each other, and a second set of embossments displaced and/or defined upon the mating surface separated approximately 180 degrees apart from each other, such that each set of embossments is separated relative to each other set by an angular spacing in the range of approximately 30-90 degrees on the mating surface.

### BACKGROUND

The subject matter disclosed herein relates generally to water filtration systems, and more particularly to filter heads and the like.

Water filters are used to extract contaminants such as chlorine, chloramine, volatile organic compounds (VOCs), lead, microbes and other undesirable substances. The presence of some such contaminants is a direct result of agricultural chemicals, industrial and municipal wastewater facility processes, water treatment and disinfection byproducts, urban runoff and/or naturally occurring sources in ground water supplies. Others contaminants are introduced after treatment processes within the home and/or municipal sources, for example, from piping and contact with contaminant items.

Household filters can generally be broken into two classes: Point of Entry (POE) filters and Point of Use (POU) filters. POE filters are placed at the entry point of water into the home and continuously filter all water that enters the home. POU filters are installed in areas such as kitchen sinks and refrigerators where water may be used for direct consumption.

A water filter system includes inlet/outlet tubing, a manifold and a filter component. The manifold receives untreated water, directs the water into a filter media, which subsequently directs the treated/filtered water back out for use. The filter media can vary depending on the contaminants targeted for removal. Sediment filters will take out fairly coarse particulate matter greater than 10 microns. Carbon filters, which generally include 60-70% carbon, 2-5% scavenger additives such as titantium dioxide, and 25-40% polyethylene binder dust, will extract contaminants such as chlorine, lead, VOCs, pharmaceuticals, particulates larger than 0.5 microns, and some large microbes such as cysts. The scavenger additives are included to shore-up the block's ability to remove those contaminants that carbon does not have an affinity to adsorb such as heavy metals like lead. Hollow fiber technology, ozone, ultraviolet (UV) lamps and quaternary technologies are also used to extract or destroy microbes, which can be as small as 0.015 microns. In virtually all cases, the filter media will be exhausted over time and use and need to be replaced in order to restore the system's ability to remove contaminants.

Existing water filter heads generally include an inlet check valve feature and a returning outlet feature essentially in line with water supply lines tying into the head. As advances are made in filtration performance (improved reduction, the ability to remove more and finer contaminants, bacteria/virus reduction, higher flow rates, etc.), changes are made within the reusable mounting component referred to as the manifold to enable new filter systems to incorporate the enhanced capabilities.

With improving filter cartridge technology, new systems can achieve the required level of contaminant removal using higher flow rates than older systems. However, use of the older cartridges in the new higher flow rate systems could result in the filter cartridge not performing at its rated removal level because of the system flow rate is higher than that for which the cartridge was designed. Similarly, the useful life of the cartridges militates against use of older lower flow rate cartridges in the new higher flow rate systems. For example, if an older filter rated to have a useful flow through life of approximately 125 gallons when operated at a flow rate of 0.5 gallons per minute (gpm) were to be placed into a newer system that may operate at a flow rate of 0.75 gpm, at that higher flow rate its expected life would be only 75 gallons. To avoid the under-performance resulting from use of older style cartridges in the newer systems, the cartridge manifold interface in the newer systems are designed to prevent the insertion of older style cartridges in the new manifolds.

Commonly, there is more of a pressure loss through the manifold in old systems than through the manifold in newer systems due to varied check valve geometry and flow configuration. Accordingly, as noted, old system canisters placed into a newer system manifold will produce a flow faster than in the old system manifold, which can create a regulatory problem where an advertised flow rate does not apply, as well as leading to a scenario where capacity would drop with the increased flow rate. As such, it would be advantageous to create a new cartridge that can be placed into old system manifolds that leads to a capacity increases as flow rate decreases.

Also, however, features added within newer systems to prevent the use of old cartridges with the new system tend to also preclude use of new cartridges into the older systems. Nonetheless, it can be advantageous to enable new replacement filter cartridges to be capable of being installed into manifolds of older systems as well as newer, enhanced flow systems. For example, as briefly noted above, if a new high flow rate cartridge were to be installed in an older/existing manifold, at the lower flow rate of the older system, the life of the cartridge can actually be extended such that a cartridge rated at 125 gallon at 0.75 gpm would actually last 200 gallons when used in a system with a flow rate of 0.5 gpm. In such situations, while older systems will not fully utilize the enhanced capabilities of the newer cartridges, the newer cartridges will perform at least at the old system levels. So, having new cartridges that are compatible with the older system would avoid the need to provide separate cartridge models. However, challenges exist in facilitating the compatibility of new cartridge filter heads with developing filtration technology, to the older manifolds.

Accordingly, it would be advantageous to the consumer in both price and selection to offer a filter cartridge that is compatible with both old and new manifolds, due to the economy of scale and simplicity in purchasing.

### BRIEF DESCRIPTION OF EXAMPLE EMBODIMENTS OF THE INVENTION

As described herein, the exemplary embodiments of the present invention overcome one or more disadvantages known in the art. Embodiments of the invention provide apparatus that are compatible with newer system flow paths, wherein untreated water is direct downward through a horizontal surface via slots and/or holes and outward of the filter media within the canister. Additionally, as detailed herein, embodiments of the invention are compatible with old systems, wherein untreated water is forced, via pressure, radially inward through the filter media and directed back through the center of the canister cap into the manifold and ultimately out of the system.

A first aspect of the present invention relates to a filter canister apparatus for engagement with a manifold including an inlet annular recess defined by a mating surface, and at least a first set of embossments displaced and/or defined upon the mating surface separated approximately 180 degrees apart from each other, and a second set of embossments displaced and/or defined upon the mating surface separated approximately 180 degrees apart from each other, such that each set of embossments is separated relative to each other set by an angular spacing in the range of approximately 30-90 degrees on the mating surface.

Another aspect of the invention relates to a fluid filtration system in conjunction with the first aspect of the invention which includes a manifold having a manifold inlet port and a manifold outlet port, a check valve being disposed for fluidly sealing at least one of said ports, a flow inlet channel leading to the check valve, the manifold inlet port being operably fluidly coupled to a fluid source for receiving a flow of fluid and to a flow inlet channel, the manifold outlet port being fluidly coupled to a flow outlet channel, the flow inlet channel having an intake opening for directing fluid conveyed therein, the intake opening defined in a margin of a depending inlet boss of the manifold, and an outlet boss depending from the inlet boss and having a circumferential outer margin, the outlet boss also having an outlet opening for directing fluid conveyed therein, the outlet opening being fluidly coupled to the flow outlet channel, the flow outlet channel fluidly coupling the outlet opening to the manifold outlet port.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 illustrates a water filter apparatus, in accordance with a non-limiting example embodiment of the invention;

FIG. 2 illustrates components of a water filter apparatus, in accordance with a non-limiting example embodiment of the invention;

FIG. 3 illustrates components of a filter canister, in accordance with a non-limiting example embodiment of the invention;

FIG. 4 illustrates a cross-section view of a water filter apparatus, in accordance with a non-limiting example embodiment of the invention;

FIG. 5 illustrates an uninstalled position and installed position of a manifold and filter canister, in accordance with a non-limiting exemplary embodiment of the invention;

FIG. 6 illustrates a side view image of a bayonet, in accordance with a non-limiting example embodiment of the invention;

FIG. 7 illustrates exploded and cross-section views of the filter canister cap and insert component, in accordance with a non-limiting example embodiment of the invention;

FIG. 8 presents a cross-section image of a head interface of a filter canister with four raised embosses, in accordance with a non-limiting exemplary embodiment of the invention;

FIG. 9 presents a cross-section image of a bayonet installed in the head of a filter canister, in accordance with a non-limiting exemplary embodiment of the invention; and

FIG. 10 illustrates an overhead and cross-section view of a manifold and filter canister, in accordance with a non-limiting exemplary embodiment of the invention.

### DETAILED DESCRIPTION OF EXAMPLE EMBODIMENTS OF THE INVENTION

As described herein, one or more embodiments of the invention include an apparatus including a multiple-embossment interface for engaging with a filter head check valve feature for a water filter. Such an apparatus can be implemented, for example, in a household water filter, such as one incorporated with a home sink or faucet to facilitate filtered water coming out of a home tap. As illustrated in the figures described below, at least one embodiment of the invention includes a water filter canister having a canister body with a canister cap that houses a filter media, and a manifold having a manifold body, a check valve assembly, and a bayonet assembly. The canister cap can include features on a horizontal surface of a cap insert component that encloses the filter media within the canister body. Such features can include, for example, a first set of embossments (raised protrusions and/or recessed depressions) spaced approximately 180 degrees about the canister center axis apart from one another and a second set of embossments (raised protrusions and/or recessed depressions) spaced approximately 180 degrees about the canister center axis apart from one another, and each set of embossments spaced from each other by an angular spacing of in the range of 30-90 degrees. A spacing of 90 degrees is employed in the illustrative embodiments. This spacing between sets avoids the need for more than two sets of embossments.

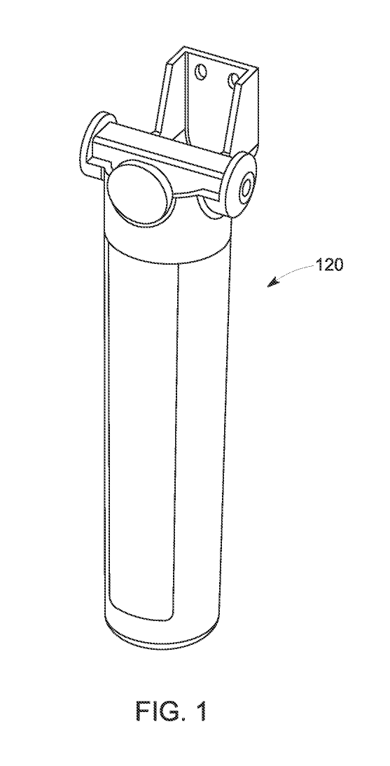

FIG. 1 illustrates a water filter apparatus 120, in accordance with a non-limiting exemplary embodiment of the invention. Individual components that constitute water filter apparatus 120 are depicted in the subsequent figures, and the individual components illustrated therein (as well as the numerical labels corresponding thereto) are used herein in describing one or more embodiments of the invention.

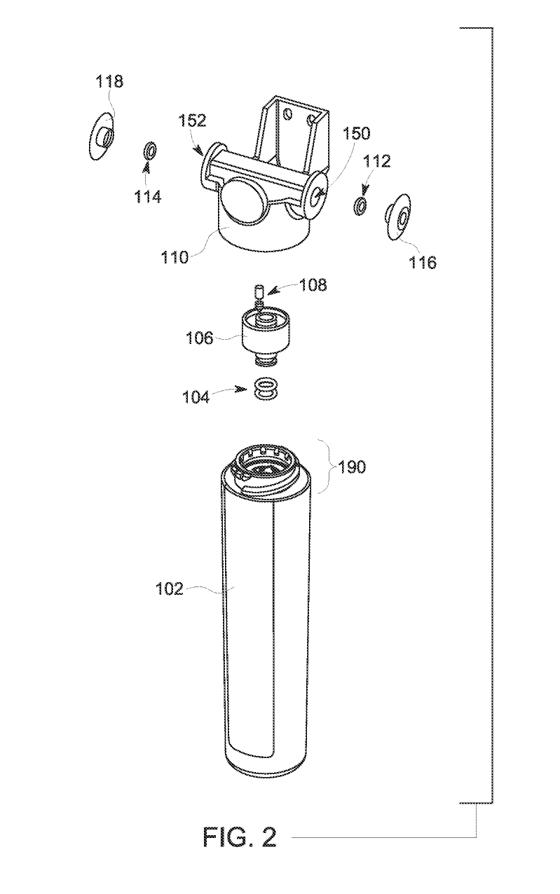

Accordingly, FIG. 2 presents components of the water filter apparatus 120 of FIG. 1, in accordance with a non-limiting exemplary embodiment of the invention. By way of illustration, FIG. 2 depicts a filter canister 102, o-rings 104, a bayonet 106, a check valve 108, a manifold body 110, o-ring 112 and o-ring 114, and speed-fit cap 116 and speed-fit cap 118. As shown in FIG. 2, the filter canister 102 additionally includes an annular canister interlocking member 190. Additionally, the manifold body 110 includes a manifold inlet port 152 and manifold outlet port 150. These components are discussed in further detail herein.

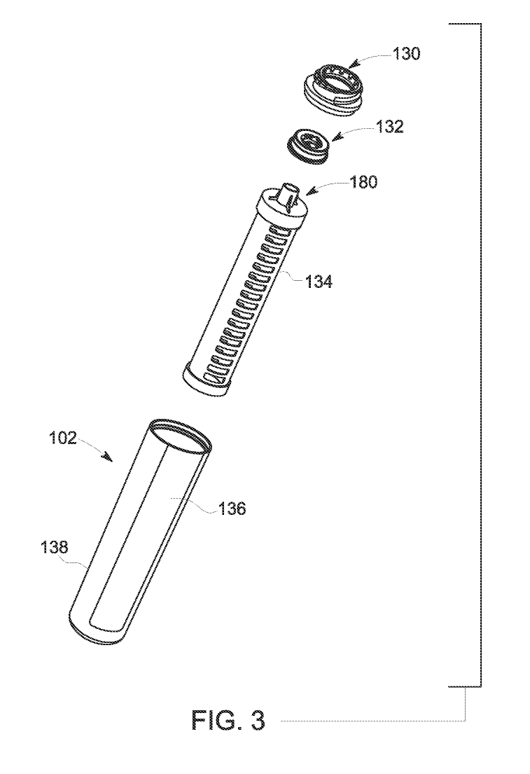

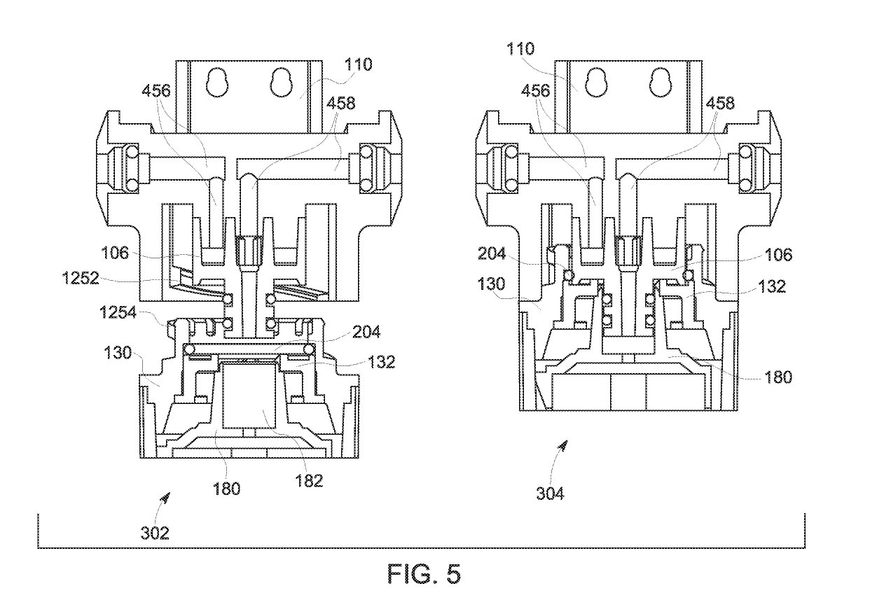

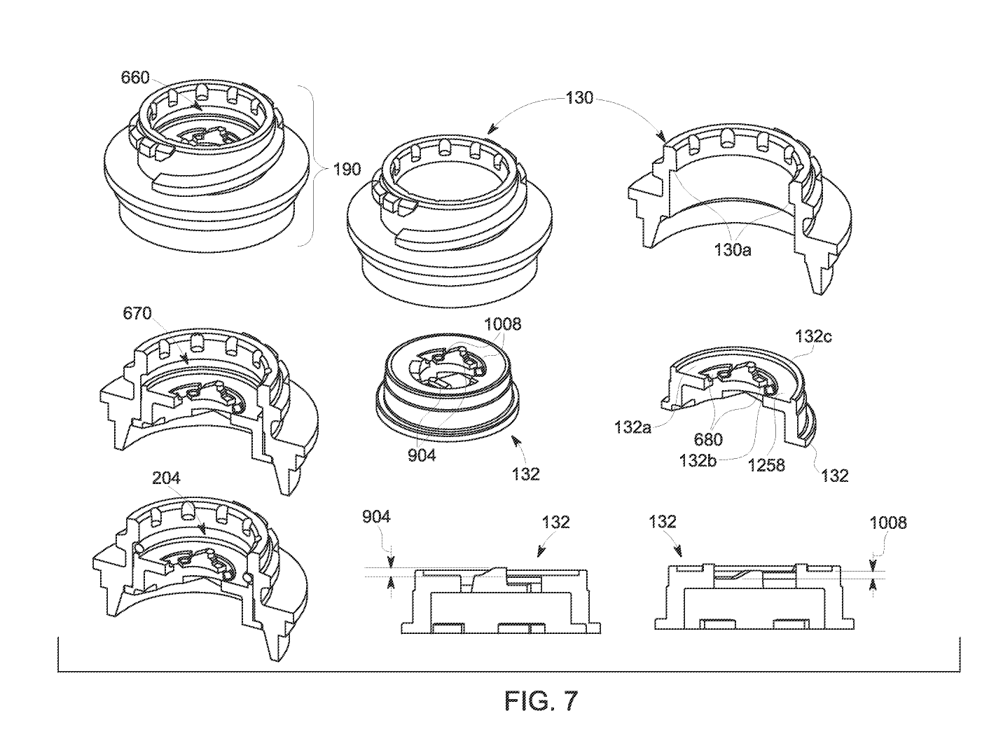

FIG. 3 illustrates components of the filter canister 102, in accordance with a non-limiting exemplary embodiment of the invention. By way of illustration, FIG. 3 depicts a filter cap 130 and an insert component 132, which comprise the annular canister interlocking member 190. In at least one embodiment of the invention, the annular canister interlocking member 190 can include a compression seal (such as, for example, in the form of an o-ring 204 as depicted in FIG. 5 and FIG. 7) positioned on the inner surface of the member 190. Additionally, in at least one embodiment of the invention, the insert component 132 enables various methods of engaging the check valve 108. The engagement amount of the check valve 108 can vary from, for example, 0.050 inches to 0.1875 inches depending on how far the check valve is to be pushed up. In an example embodiment, a 1/16″ diameter o-ring can be pushed around the check valve 108 up almost 1/16″ to break seal. Additional embodiments can include pushing higher (0 to 0.125″) to facilitate higher flow rates if desired or needed. Accordingly, in at least one embodiment of the invention, the check valve 108 engages the insert component 132 upon rotation of the filter canister 102 upon an approximately quarter turn of the filter canister 102, opening a passage-way through which fluid can pass.

FIG. 3 also depicts a media adapter cap 180 and a filter media structure assembly 134. As known in the art, the filter media structure assembly 134 can include one of multiple compositions. For example, the structure assembly can include carbon, a reverse osmosis membrane, an ultra-filtration component (such as a hollow fiber cartridge), etc. Additionally, as depicted in FIG. 3, the filter canister 102 can include a polypropylene canister portion 136 and a soft touch santoprene canister portion 138.

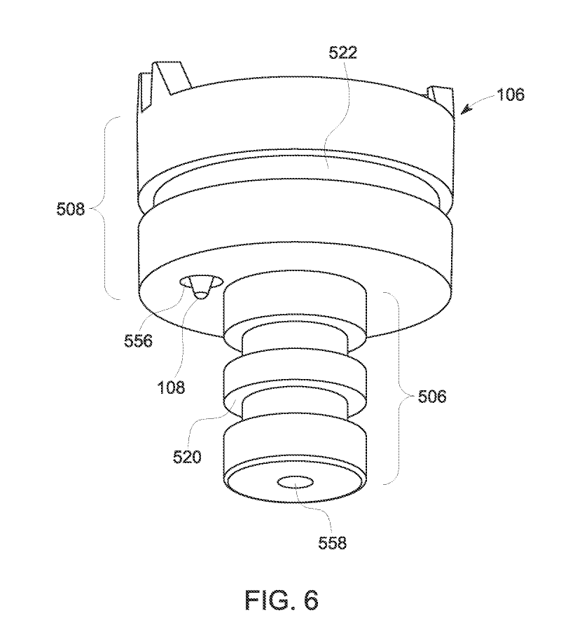

Also, at least one embodiment of the invention includes attaching a cartridge to a water filter head assembly, and more specifically, at least one embodiment of the invention includes adding an elastomeric seal component (such as, for example, o-ring 204 as depicted in FIG. 5 and FIG. 7) to the mating surface provided by the inner periphery of the annular canister interlocking member 190 to sealingly engage the external cylindrical surface of the inlet boss portion (depicted as component 508 in FIG. 6) of the bayonet 106 as the filter canister 102 is installed.

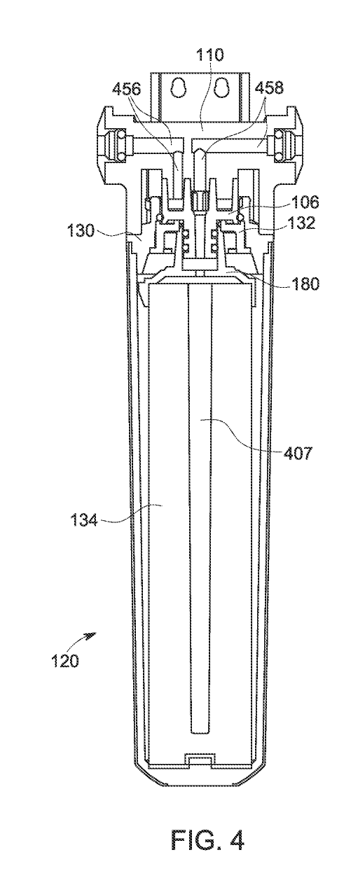

FIG. 4 illustrates a cross-section view of water filter apparatus 120, in accordance with a non-limiting exemplary embodiment of the invention. Specifically, FIG. 4 shows manifold body 110, bayonet 106, a flow inlet channel 456 defined within the manifold body 110 leading to the check valve 108, and a flow outlet channel 458 defined in the manifold body 110. The manifold inlet port 152 is operably fluidly coupled to a fluid source for receiving a flow of unfiltered fluid, and is also fluidly coupled to the flow inlet channel 456. The manifold outlet port 150 is fluidly coupled to flow outlet channel 458.

FIG. 4 also shows filter canister cap 130, insert component 132, media adapter cap 180, and the filter media structure assembly 134. As is known in the art, there are commonly two different filter media structure assembly types—carbon blocks and hollow fiber. The hollow fiber includes a plastic outer shell that contains the hollow fiber into a bundle. This bundle is potted in the shell such that water passes from outside the fibers into the center of individual fibers, where it flows through the fiber to a common outlet atop the cartridge. The insert component 132 (or in one or more embodiments, the filter canister cap 130) includes a centrally located hole or channel on the horizontal surface that acts to locate the filter media structure assembly 134 radially within the filter canister 102 and direct fluid thereto. The upwardly extending cylindrical portion of the media adapter cap 180 fits into the centrally located hole in insert component 132 to locate the media. Further, the media adapter cap 180 can be a portion of the filter media structure assembly 134 or coupled to the filter media structure assembly 134 as a separate component.

As noted above, new filters are being engineered to extract more contaminants at higher flow rates due to changes in both the media and filter geometry. By way of example, cartridges filled with hollow fiber media can be capable of removing bacterial and viral microorganisms down to a 15 nanometer size. Another media, as mentioned, includes a traditional carbon block, where the surface area has been increased by almost 50% but volume correspondingly only by approximately 20%.

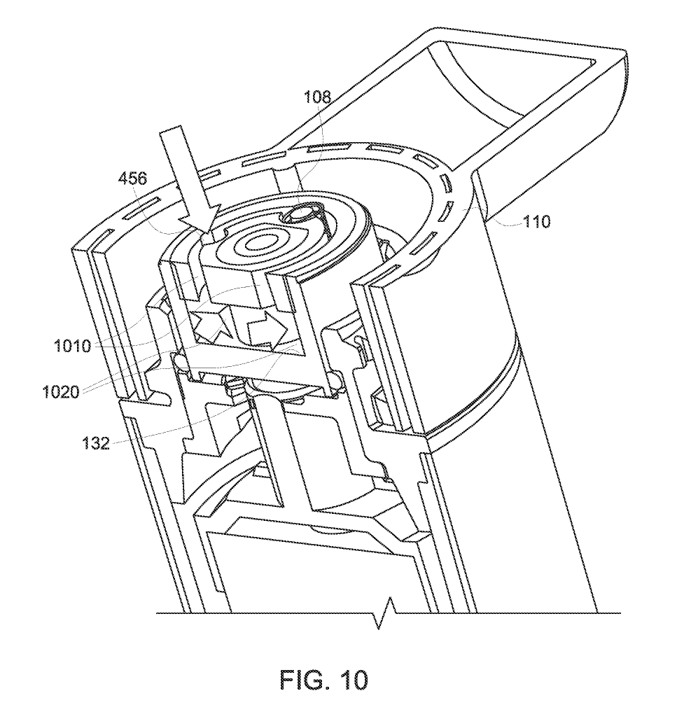

FIG. 5 presents an image representing the uninstalled position 302 and installed 304 position of the manifold body 110 and filter canister 102. Specifically, FIG. 5 illustrates components of the manifold body 110 and filter canister 102 minus the presence of check valve 108 to more clearly detail the flow path developed between the two components. FIG. 9 depicts a zoomed-in view of the bayonet 106 and the filter canister 102 engagement that includes the check valve 108, such as envisioned by an example embodiment of the invention, positioned within flow inlet channel 456.

In addition to the components also depicted in FIG. 4, FIG. 5 illustrates a spiraling shoulder flange 1252 on the manifold body 110 and a flange 1254 on the filter canister cap 130. Rotation of the flange 1254 on the filter canister cap 130 with respect to the manifold flange 1252 on the manifold body 110 acts to engage the filter canister 102 and the manifold body 110 and draw them together in an axial direction into a tight fit. Additionally, FIG. 5 identifies o-ring 204, which is described further in connection with FIG. 7. Moreover, the uninstalled 302 and installed 304 position of the manifold body 110 and filter canister 102 depicted in FIG. 5 illustrate how the bayonet 106 fits into the filter canister 102 and more specifically how inlet boss (depicted as component 508 in FIG. 6) of the bayonet 106 is received in sealing engagement with a first mating surface provided in this embodiment by an interior annular surface 660 of interlocking member 190, which is formed by the inner surface of the side wall of filter canister cap 130 together with the upwardly extending outer rim 132c of insert component 132, as further illustrated in FIG. 7.

Additionally, FIG. 5 depicts how outlet boss 506 is received into the inlet annular recess defined in this embodiment by the hollow cylindrical interior 182 of media adapter cap 180 and seals off against a second mating surface illustratively embodied by the interior surface of the upwardly extending cylindrical sidewall of the media adapter cap 180. It should be noted that in this embodiment this second mating surface is continuous and has no sealing means.

FIG. 6 illustrates a side view image of bayonet 106. As described herein, bayonet 106 is a protrusion that comes down off of the bottom of the manifold body 110 for sealing engagement with the filter canister 102. As noted, the bayonet 106 can, by way of example, be welded via ultrasonic, spin, or heat-stake means into the manifold body 110, thereby establishing a water flow path. The smaller diameter portion, also referred to herein as an outlet boss 506 of the bayonet 106, which includes annular spaces 520 for fitting o-rings 104 if desired, fits into the hollow cylindrical interior 182 of media adapter cap 180 in the middle of filter canister 102 to form a seal therebetween. By way of illustration, FIG. 4 depicts a double o-ring seal engaging the media adapter cap 180 of the filter media, wherein the o-rings (such as depicted as components 104 in FIG. 2) squeeze into the media adapter cap 180 to form a seal.

The fluid exiting the filter travels up through the flow outlet channel 458 (as depicted in FIG. 4) in the middle of the bayonet 106 and is ultimately directed out of the manifold body 110. The seal between outlet boss 506 and the filter canister 102 prevents the water exiting the filter canister 102 from leaking around outlet boss 506. The larger diameter portion, also referred to herein as an inlet projection or inlet boss 508 of the bayonet 106, provides a surface for sealingly engaging the filter canister 102 and more particularly for sealingly engaging a mating surface provided in this embodiment by an interior annular surface 660 of interlocking member 190, which is formed by the inner surface of the side wall of cap 130 together with the outer rim 132c of insert component 132, as hereinafter more fully described in reference to FIG. 7, to prevent the unfiltered fluid entering the filter canister 102 through the check valve 108 from leaking to the ambient environment outside of the manifold body 110.

As described and depicted herein, bayonet 106 includes the flow inlet channel 456 (as depicted in FIG. 4) around check valve 108 having a discharge opening 556 for discharging the fluid conveyed therein to the filter canister 102. The discharge opening 556 is defined in a lower margin of depending inlet boss 508. The inlet boss 508 has a circular cross section defined about a longitudinal axis and a circumferential outer margin. The discharge opening 556 is radially displaced from the longitudinal axis. Boss sealing means can include o-rings positioned in annular space 522 to seal the space between the inlet boss 508 and the inner periphery of the filter canister cap 130 when fully assembled. Additionally, an outlet opening 558 is fluidly coupled to the flow outlet channel 458. Further, the flow outlet channel 458 fluidly couples the outlet opening 558 to the manifold outlet port 150.

Accordingly, the bayonet 106 receives fluid flow from the manifold inlet port 152 in the manifold body 110. The bayonet 106 distributes the flow into the inlet boss 508 to the discharge opening 556 defined in the lower margin of the bayonet 106. Further, as is known in the art, structural support features above the discharge opening 556 can be provided to align and guide the movement of the check valve 108 along the longitudinal axis of the discharge opening 556.

As noted above, when engaged with the filter canister 102, the large diameter cylinder or inlet boss 508 provides a sealing surface for engagement with a first mating surface provided by an interior annular surface 660 of interlocking member 190, which is formed by the inner surface of the side wall of cap 130 together with the upwardly extending rim 132c of insert component 132, to provide a seal between the incoming, unfiltered fluid and ambient environment. The smaller diameter cylinder or outlet boss 506, when engaged with the filter canister 102, fits and forms a seal against cylindrical interior 182 of media adapter cap 180 and directs filtered fluid toward the exit of the manifold body 110. Each of these bayonet cylinders may, merely by way of example, include an o-ring or a set of o-rings as well as a set of glands to facilitate a proper seal.

On the bottom horizontal surface of the inlet boss 508, a plunger of the check valve 108 protrudes downward and is biased into this position via a mechanical spring within the check valve 108. This plunger is depressed upward as it engages a complementary surface on the filter canister 102 (for example, upon mating surface 1258 of insert component 132) when the filter canister 102 is being installed in the manifold body 110, with said surface comprising embossments such as detailed in accordance with at least one embodiment of the invention and depicted in FIG. 7 through FIG. 9.

FIG. 7 illustrates exploded and cross-section views of the filter canister cap 130 and insert component 132. Additionally, FIG. 7 depicts the annular canister interlocking member 190, including the interior annular surface 660 of interlocking member 190, which comprises a first mating surface as detailed herein. Further, FIG. 7 depicts an o-ring groove 670 for receiving and retaining o-ring 204. The groove 670 is formed, in the embodiment illustrated in FIG. 7, in the first mating surface formed by the upper edge of rim 132c on the insert component 132 and the inner bottom annular surface 130a on the filter canister cap 130 proximate the intersection of the filter canister cap 130 and insert component 132. Additionally, the insert component 132, in at least one embodiment of the invention, is spun welded into the filter canister cap 130. In an example embodiment, the o-ring 204 sealingly engages the vertical walls of the inlet boss 508 of the bayonet 106 during installation in lieu of and/or conjunction with an existing o-ring installed on the outlet boss 506 of the bayonet 106. Specifically, as detailed herein, boss sealing means of the bayonet 106 include o-rings 104 positioned in annular spaces 520 to seal the space between the outlet boss 506 and the second mating surface, provided in the embodiments herein described by the inner periphery of the filter canister cap 130, when fully assembled.

FIG. 7 also depicts an annular recess 1258 formed by the upper facing surface 132a of the insert component 132, extending between inner upwardly extending rim 132b and outer upwardly extended rim 132c, as well as slot features 680 located around the inner hole of the insert component 132. In at least one embodiment of the invention, fluid entering via discharge opening 556 in inlet boss 508 travels into the inlet recess 1258 between the bayonet 106 and the surface 132a of the insert component 132 into the interior space between the filter canister cap 130 and the exterior surface of the media adapter cap 180, through the slot features 680 located around the central hole in the insert component 132. From this region the water flows into the space between the filter media and the cylindrical wall of canister 102 and then radially inwardly through filter media structure assembly 134 to the central bore media structure 407 of the assembly 134 and exits the canister through the central opening in cap 180 to outlet channel 458 of manifold 110 which passes through outlet boss 506.

Additionally, as depicted in FIG. 7, the cap insert 132 includes raised embosses 904 and recessed depressions 1008 displaced and/or defined upon annular recess 1258, also referred to herein as mating surface 1258. According to an example embodiment of the invention, each recessed depression 1008 can be a depth of approximately 0.0625 inches, while each raised emboss 904 can be a height of approximately 0.0625 inches.

As noted herein, water enters a filter manifold 110 and travels into the bayonet 106 through a check valve 108. Depending upon its engagement with the cap insert component embossments, the check valve 108 can be moved up and down to allow water in, and once the filter is rotated into the bayonet 106, a seal forms against the o-rings 104. Specifically, for example, once the filter canister 102 is rotated into the manifold body 110, the raised embossments 904 of the filter canister push the check valve 108 up, as depicted in FIG. 9. With the check valve moved up, a flow path is opened to allow fluid to pass through.

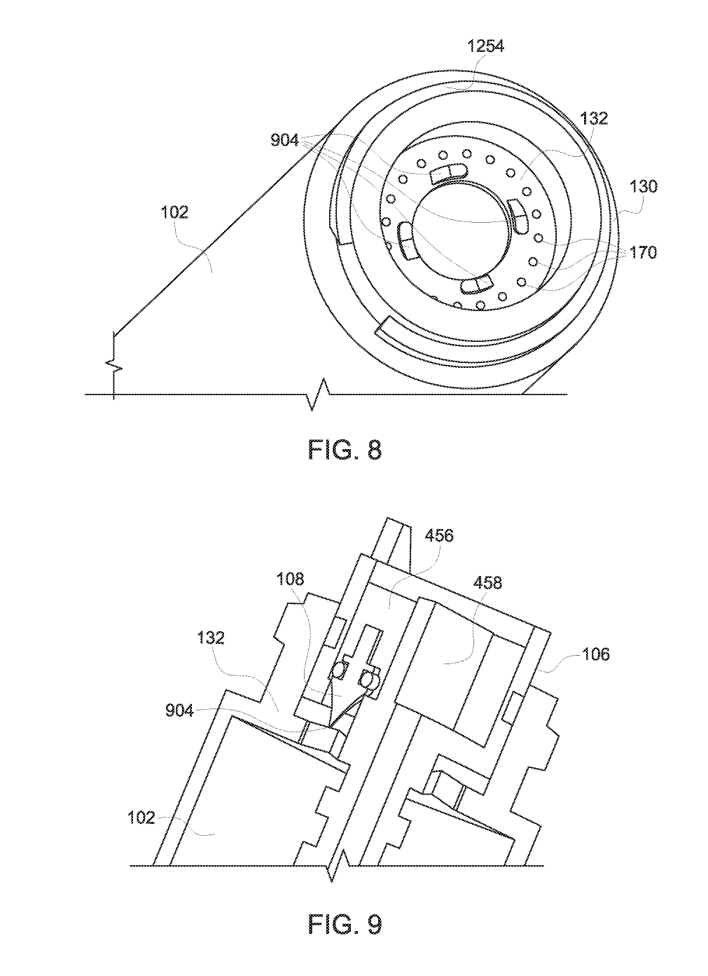

FIG. 8 presents a cross-section image of a head interface of filter canister 102 with four raised embosses 904, in accordance with a non-limiting exemplary embodiment of the invention. By way of illustration, FIG. 8 depicts four raised embossments 904 positioned approximately 90 degrees apart from one another on the mating surface 1258 of the insert component 132. As also shown in FIG. 8 and described herein, filter canister 102 includes flange 1254 on the outside of the cap 130 of the canister that threads into a manifold 110 for installation. Additionally, FIG. 8 depicts penetrations 170 on the mating surface of insert component 132 that permit incoming fluid to pass toward the filter media.

Also, in at least one additional embodiment of the invention, one or more of the embossments can be recessed elements instead of raised protrusions. For instance, a filter canister can include four embossments of 90 degree orientation: two raised embossments (for example, components 904) and two recessed embossments (for example, components 1008). Additionally, in at least one embodiment of the invention, a check valve can be of different lengths to correspond to the type of embossment (that is, raised or recessed).

As noted herein, the bayonet 106 is a stationary component in the overall apparatus. The manifold 110 has an external helical shoulder (shown, for example, as component 1252 in FIG. 5), and, as shown in FIG. 8, the canister has flange 1254 on the outside of the filter canister cap 130 of the canister, which threads into the shoulder 1252 of the manifold body 110. The manifold can remain stationary and when the consumer performs a turn (for example, a quarter-turn) of the filter canister 102, whereby the filter canister 102 is pulled up and around the bayonet 106, and the o-rings 104 on the bayonet 106 create a seal with the canister, as previously detailed herein.

FIG. 9 presents a cross-section image of bayonet 106 installed in the head of filter canister 102, in accordance with a non-limiting exemplary embodiment of the invention. By way of illustration, FIG. 9 depicts filter canister 102 with a raised embossment 904, disposed upon the surface of insert component 132. FIG. 9 additionally depicts the bayonet 106 including check valve 108. As noted above, in the FIG. 9 depiction of the engagement of the filter canister 102 and the bayonet 106, the embossment 904 is pushing the check valve 108 up, opening a flow path. Similarly, in an embodiment of the invention that includes four raised embossments, the orientation (front or back) of the replaceable filter canister is irrelevant because no matter the orientation of the canister 102, an embossment will be in position to engage the check valve 108.

In such example embodiments of the invention, the raised embossments selectively placed upon the horizontal surface of the canister cap enable compatibility with both old and newer filtration systems. By way of example, to permit the canister to be used on old filtration systems, two raised embossments, approximately 180 degrees apart, can be maintained at a height consistent with old canister embodiments to maintain equivalent performance on old systems with the new filter canisters. Also, two additional raised embossments, rotated 90 degrees from the two above-noted embossments, can be included but at different heights so as to push the check valves in the newer filtration systems by some relevant additional amount. Accordingly, by incorporating four embossments on filter canister 102 (specifically, displaced and/or defined upon mating surface 1258 of the insert component 132), embodiments of the invention can interact with existing manifolds in existing systems having a check valve with zero degree orientation, as well as engage with newer/distinct systems that have a check valve with 90 degrees orientation about the bayonet.

Additionally, when the new canisters with the additional (that is, second) set of raised embossments are used with the new manifolds that include a check valve relocated to a position 90 degrees away from the position in older systems, the frictional losses through the manifold can be reduced. This reduction is then available to be applied to the sizing of the filter media. As such, for example, volume changes to the media can result in both a shorter, more ergonomic canister height and a lower cost media.

In at least one embodiment of the invention, as detailed herein, the flow path can be moved, via a quarter-turn of the filter canister 102, from coming directly in at approximately zero degrees and travelling down into the check valve 108, and re-routed approximately 90 degrees about the longitudinal axis of the bayonet 106 to a 90 degree point on the other side of the bayonet. As noted herein, such a flow path reduces frictional losses by directing the inlet flow from a first side tube connection downward into an annular distribution ring (as more clearly depicted in FIG. 10) that guides the untreated water toward the check valve from both clockwise and counterclockwise directions, as opposed to disadvantageous existing approaches of directing the flow over and then around the check valve mechanism, where flow restrictions are numerous. In at least one embodiment of the invention, this is accomplished via the placement of the check valve rotated approximately 90 degrees relative to the filter canister vertical axis, away from the downward flow entry point into the annular ring (as more clearly depicted in FIG. 10).

Accordingly, and as described herein, embodiments of the invention can include various configurations with respect to the embossments (904 or 1008) displaced and/or defined upon mating surface 1258 of the insert component 132. For example, a first set of embossments can be a pair of raised embossments 904 at one height above the mating surface 1258 and the second set of embossments can be a pair of raised embossments 904 at a second height above the mating surface 1258 (as detailed above). Additionally, for example, the first set of embossments can be a pair of recessed depressions 1008 at one depth below the mating surface 1258 and the second set of embossments can be a pair of recessed depressions 1008 at a second depth below the mating surface 1258. Further, for example, the first set of embossments can be a pair of raised embossments 904 at one height above the mating surface 1258 and the second set of embossments can be a pair of recessed depressions 1008 at one depth below the mating surface 1258.

Also, the first set of embossments and the second set of embossments can enable dual methods of engaging the check valve 108 via the check valve 108 coming into contact with one of the protrusion embossments 904 (pushing the check valve up) or depression embossments 1008 (permitting the check valve to move downward into the depression) upon a (approximately) quarter-turn of the replaceable filter cartridge 102, opening a flow path through which fluid can pass around the check valve 108.

FIG. 10 illustrates an overhead and cross-section view of a manifold and filter canister, in accordance with a non-limiting exemplary embodiment of the invention. By way of illustration, FIG. 10 depicts, via the large, downward-pointing solid arrow, the direction of fluid into flow inlet channel 456 defined within the manifold body 110, wherein the fluid is then directed downward into an annular flow distribution ring 1010 within the manifold 110. Within the annular flow distribution ring 1010 within the manifold 110, the fluid can travel in both the clockwise and counterclockwise direction toward the check valve 108, which is aligned vertically and perpendicular to the flow within the annular flow distribution ring 1010. Additionally, as illustrated in the example embodiment of FIG. 10, as the canister is installed into the system and the check valve is engaged upward, the fluid is permitted to flow under the check valve 108 and downward (depicted via the smaller, checkered arrows) into a second annular flow distribution ring 1020 which is defined above by the bottom of the manifold 110 and on the bottom and sides by the insert component 132 (and/or filter canister cap 130). As detailed herein, such an example embodiment of the invention is compatible with newer systems as well as old system.

Accordingly, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A filter canister apparatus for engagement with a manifold, said apparatus comprising:
an inlet annular recess defined by a mating surface; and
at least a first set of embossments displaced and/or defined upon the mating surface separated approximately 180 degrees apart from each other, and a second set of embossments displaced and/or defined upon the mating surface separated approximately 180 degrees apart from each other, such that each set of embossments is separated relative to each other set by an angular spacing in the range of approximately 30-90 degrees on the mating surface.

2. The filter canister apparatus of claim 1, wherein the first set of embossments is a pair of raised embossments and the second set of embossments is a pair of raised embossments.

3. The filter canister apparatus of claim 2, wherein the first set of embossments is a pair of raised embossments of one height above the mating surface and the second set of embossments is a pair of raised embossments of a second height above the mating surface.

4. The filter canister apparatus of claim 1, wherein the first set of embossments is a pair of recessed depressions and the second set of embossments is a pair of recessed depressions.

5. The filter canister apparatus of claim 4, wherein the first set of embossments is a pair of recessed depressions defined at one depth in the mating surface and the second set of embossments is a pair of recessed depressions defined at a second depth in the mating surface.

6. The filter canister apparatus of claim 1, wherein the first set of embossments is a pair of raised embossments of one height above the mating surface and the second set of embossments is a pair of recessed depressions defined at one depth in the mating surface.

7. The filter canister apparatus of claim 1, further comprising at least one annular cartridge interlocking member disposed radially outward of the inlet annular recess.

8. The filter canister apparatus of claim 7, wherein the at least one annular cartridge interlocking member comprises an outer annular cartridge interlocking member and an inner annular cartridge interlocking member.

9. The filter canister apparatus of claim 1, wherein the check valve engages one embossment from the first set of embossments or the second set of embossments on the horizontal interlocking member surface upon rotation of the canister apparatus by the check valve coming into contact with the embossment upon an approximately quarter turn of the filter canister apparatus.

10. The filter canister apparatus of claim 1, comprising a filter media component.

11. The filter canister apparatus of claim 10, wherein the mating surface includes one or more through penetrations that permit incoming fluid to pass toward the filter media component.

12. A fluid filtration system comprising:
a manifold having a manifold inlet port and a manifold outlet port, a check valve being disposed for fluidly sealing at least one of said ports, a flow inlet channel leading to the check valve, the manifold inlet port being operably fluidly coupled to a fluid source for receiving a flow of fluid and to a flow inlet channel, the manifold outlet port being fluidly coupled to a flow outlet channel,
the flow inlet channel having an intake opening for directing fluid conveyed therein, the intake opening defined in a margin of a depending inlet boss of the manifold, and
an outlet boss depending from the inlet boss and having a circumferential outer margin, the outlet boss also having an outlet opening for directing fluid conveyed therein, the outlet opening being fluidly coupled to the flow outlet channel, the flow outlet channel fluidly coupling the outlet opening to the manifold outlet port; and
a filter canister apparatus comprising:
an inlet annular recess defined by a mating surface, and
at least a first set of embossments displaced and/or defined upon the mating surface separated approximately 180 degrees apart from each other, and a second set of embossments displaced and/or defined upon the mating surface separated approximately 180 degrees apart from each other, such that each set of embossments is separated relative to each other set by an angular spacing in the range of approximately 30-90 degrees on the mating surface.

13. The fluid filtration system of claim 12, wherein the first set of embossments is a pair of raised embossments and the second set of embossments is a pair of raised embossments.

14. The fluid filtration system of claim 13, wherein the first set of embossments is a pair of raised embossments of one height above the mating surface and the second set of embossments is a pair of raised embossments of a second height above the mating surface.

15. The fluid filtration system of claim 12, wherein the first set of embossments is a pair of recessed depressions and the second set of embossments is a pair of recessed depressions.

16. The fluid filtration system of claim 15, wherein the first set of embossments is a pair of recessed depressions defined at one depth in the mating surface and the second set of embossments is a pair of recessed depressions defined at a second depth in the mating surface.

17. The fluid filtration system of claim 12, wherein the first set of embossments is a pair of raised embossments of one height above the mating surface and the second set of embossments is a pair of recessed depressions defined at one depth in the mating surface.

18. The fluid filtration system of claim 12, further comprising at least one annular cartridge interlocking member disposed radially outward of the inlet annular recess.

19. The fluid filtration system of claim 18, wherein the at least one annular cartridge interlocking member comprises an outer annular cartridge interlocking member and an inner annular cartridge interlocking member.

20. The fluid filtration system of claim 12, wherein the check valve engages one embossment from the first set of embossments or the second set of embossments on the horizontal interlocking member surface upon rotation of the canister apparatus by the check valve coming into contact with the embossment upon an approximately quarter turn of the filter canister apparatus.
